(19) United States
(12) Patent Application Publication
(10) Pub. No.: US 2020/0005579 A1
(43) Pub. Date: Jan. 2, 2020

(54) EMV CHIP SPINNER CARDS AND METHODS FOR THEIR PREPATION

(71) Applicant: Jonny B. Vu, San Jose, CA (US)

(72) Inventor: Jonny B. Vu, San Jose, CA (US)

(21) Appl. No.: 16/007,912

(22) Filed: Jun. 13, 2018

(51) Int. Cl. G07F 7/02; G06Q 20/34

(52) U.S. Cl. CPC G07F 7/025; G06Q 20/341

(57) ABSTRACT

A credit card or debit card includes at least one rotatable disk arranged onto a top face or a bottom face of the credit card or debit card; and one or more EMV chips arranged onto the at least one rotatable disk.

### FIELD OF THE INVENTION

The invention generally relates to an EMV chip card and more particularly, to an EMV chip spinner card, wherein one or more EMV chips can be placed onto a rotatable disk or spinner on a blank credit card or debit card.

### BACKGROUND OF THE INVENTION

Credit cards and debit cards were originally developed using a magnetic strip or mechanical imprint to read and record account data, with the customer's signature being used for verification. Under this system, the customer handed their card to the clerk at the point of sale, who either swiped the card through a magnetic reader or made an imprint from the raised text on the card. With the magnetic reader, the system verified the account information and printed a slip for the customer to sign. For the imprinted text, the transaction details were filled in and the customer signed the imprinted slip. In both cases, the clerk verified that the customer's signature matched the signature on the back of the card. While being convenient and useful, these systems have a number of security flaws, including reading and writing the magnetic strip of the card during a transaction or by copying the card's information, making these cards easy to duplicate and use without the owner's knowledge.

To address this problem, smart cards (also called chip cards or IC cards) were developed, which have the ability to store a user's account data on an integrated circuit. EMV chips, which stands for Europay, MasterCard, and Visa, were developed as a technical standard for smart cards and for payment terminals and automated teller machines that can accept them. EMV chips store their data on integrated circuits as well as on magnetic strips for backward compatibility. These cards can be physically inserted into a card reader or can be read over short distances using radio-frequency identification (RFID) technology. Payment cards that comply with the EMV standard are often called Chip and PIN or Chip and Signature cards, depending on the authentication methods employed by the card issuer.

Most plastic credit cards and debit cards issued by banks and credit card companies are boring and unimpressive to look at for the average consumer. These institutions sometimes offer cards with various sports team designs or “cute” animal designs that may liven up the plastic card's look and appeal, however, the standard bank or credit card company logo is usually included on the card issued to the owner. As such, there is nothing that distinguishes an affluent, sophisticated card holder from an average card holder. Therefore, there remains a need in the art for new types of credit cards and debit cards that are more appealing to the average consumer.

### SUMMARY OF THE INVENTION

The disclosure addresses these needs and more by providing a credit card or debit card, which includes at least one rotatable disk arranged onto a top face or a bottom face of the credit card or debit card; and one or more EMV chips arranged onto the at least one rotatable disk.

The disclosure also provides methods for preparing a credit card or debit card, which includes removing one or more EMV chips from one or more credit cards or debit cards; trimming off any excess glue or plastic from the removed one or more EMV chips; and inserting the trimmed one or more EMV chips onto a rotatable disk arranged onto a top face or a bottom face of a credit card or debit card.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, size, or applicability of the disclosure. It should be noted that for clarity and ease of illustration these drawings are not necessarily made to scale.

FIG. 1 illustrates an embodiment of a bottom, front, side view of a chip cutter with a square opening, base, handle, and cutting edge that corresponds with the square opening;

FIG. 2 illustrates an embodiment of an elevated, rear, side view of the chip cutter;

FIG. 3 illustrates an embodiment of an elevated, front, side view of a plastic credit card or plastic debit card with an EMV chip being inserted into a chip cutter;

FIG. 4 illustrates an embodiment of an elevated, front, side view of a plastic credit card or plastic debit card after being inserted into a chip cutter with an EMV chip cut away or removed from the card;

FIG. 5 illustrates an embodiment of an elevated, front, side view of cigar cutter with an EMV chip located overhead of the cutter before insertion;

FIG. 6 illustrates an embodiment of an elevated, front, side view of a cigar cutter with a cut out EMV chip after being inserted into the cutter and the bottom plastic and/or glue removed from the chip.

FIG. 7 illustrates an embodiment of an exploded, elevated, front, side view of a credit card or debit card with a disk, multiple EMV chips, and a display screen; and

FIG. 8 illustrates an embodiment of an elevated, front, side view of a credit card or debit card with a disk, multiple EMV chips, and an electronic display screen.

### DETAILED DESCRIPTION OF THE EMBODIMENTS

The following description is presented to enable a person of ordinary skill in the art to make and use embodiments described herein. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. The word “exemplary” is used herein to mean “serving as an example illustration.” Any aspect or design described herein as “exemplary” is not necessarily to be construed as preferred or advantageous over other aspects or designs. Thus, the present disclosure is not intended to be limited to the examples described herein and shown but is to be accorded the scope consistent with the claims.

It should be understood that the specific order or hierarchy of steps in the process disclosed herein is an example of exemplary approaches. Based upon design preferences, it is understood that the specific order or hierarchy of steps in the processes may be rearranged while remaining within the scope of the present disclosure. Any accompanying method claims present elements of the various steps in a sample order and are not meant to be limited to the specific order or hierarchy presented.

In one embodiment, the disclosure provides a credit card or debit card, which includes at least one rotatable disk arranged onto a top face or a bottom face of the credit card or debit card; and one or more EMV chips arranged onto the at least one rotatable disk.

In another embodiment, the disclosure provides methods for preparing a credit card or debit card, which includes removing one or more EMV chips from one or more credit cards or debit cards; trimming off any excess glue or plastic from the removed one or more EMV chips; and inserting the trimmed one or more EMV chips onto a rotatable disk arranged onto a top face or a bottom face of a blank credit card or debit card.

In one aspect, the disclosure provides a credit card or debit card, wherein the at least one rotatable disk is reversibly attached to the blank credit card or debit card.

In another aspect, the disclosure provides a credit card or debit card, wherein the at least one rotatable disk is level with the top face or the bottom face of the blank credit card or debit card.

In another aspect, the disclosure provides a credit card or debit card, which further includes at least one slot for securing an EMV chip in the at least one rotatable disk.

In another aspect, the disclosure provides a credit card or debit card, wherein the at least one rotatatable disk includes 1 to 6 slots for holding 1 to 6 EMV chips, respectively.

In another aspect, the disclosure provides a credit card or debit card, wherein the one or more EMV chips are located on a periphery of the at least one rotatable disk.

In another aspect, the disclosure provides a credit card or debit card, wherein 1 to 6 EMV chips are located on the periphery of the at least one rotatable disk.

In another aspect, the disclosure provides a credit card or debit card, which further includes at least one mark in the at least one rotatable disk identifying each of the one or more EMV chips, respectively.

In another aspect, the disclosure provides a credit card or debit card, which further includes at least one display screen, wherein a chosen EMV chip triggers card information onto the display screen.

In another aspect, the disclosure provides a credit card or debit card, wherein the blank credit card or debit card is a blank stainless-steel metal credit card or stainless-steel metal debit card.

Accordingly, FIGS. 1-8 illustrate exemplary embodiments of the credit card or debit card, which includes the at least one rotatable disk arranged onto a top face or a bottom face of the credit card or debit card; and one or more EMV chips arranged onto the at least one rotatable disk, and methods for making the same.

For example, FIG. 1 illustrates an embodiment of a bottom, front, side view of a chip cutter (101), i.e., a 1-hole punch, having a square opening (102), with a base (103), handle (104), and cutting edge (not shown), which corresponds with the square opening (102).

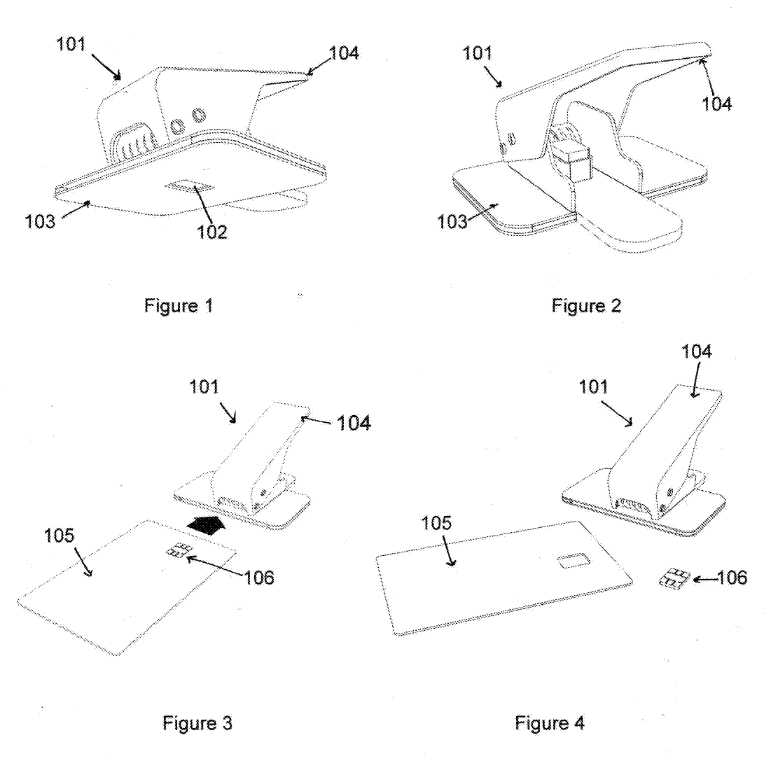

FIG. 2 illustrates an embodiment of an elevated, rear, side view of the chip cutter (101) having the features described above.

Many 1-hole punch systems can be used as a chip cutter and most are commercially available. Alternatively, a sharp edge knife, blade or other suitable device can be used to remove an EMV chip from the plastic credit or debit card.

FIG. 3 illustrates an embodiment of an elevated, front, side view of a plastic credit card or plastic debit card (105) with an EMV chip (106) being inserted into the chip cutter (101). In this embodiment, the EMV chip (106) can be removed from the plastic credit card or debit card (105) through use of the chip cutter (101). The chip cutter (101) can be used in a conventional way, in which the plastic credit card or plastic debit card (105) with the EMV chip (106) therein, is inserted into the chip cutter (101) and the handle (104) can be manually pressed down onto the area surrounding the EMV chip (106), and the EMV chip (106) cut away or removed from the plastic credit card or plastic debit card (105).

FIG. 4 illustrates an embodiment of an elevated, front, side view of the plastic credit card or plastic debit card (105) after being inserted into the chip cutter (101) with the EMV chip (106) cut away or removed from the plastic credit card or plastic debit card (105).

Once the EMV chip is removed from the plastic credit card or plastic debit card, the chip typically contains excess plastic and/or glue attached to the back. The excess plastic and/or glue can be removed using any suitable instrument including but not limited to, use of a sharp blade, razor, or knife. In one embodiment, the excess plastic and/or glue can be removed using a cigar cutter.

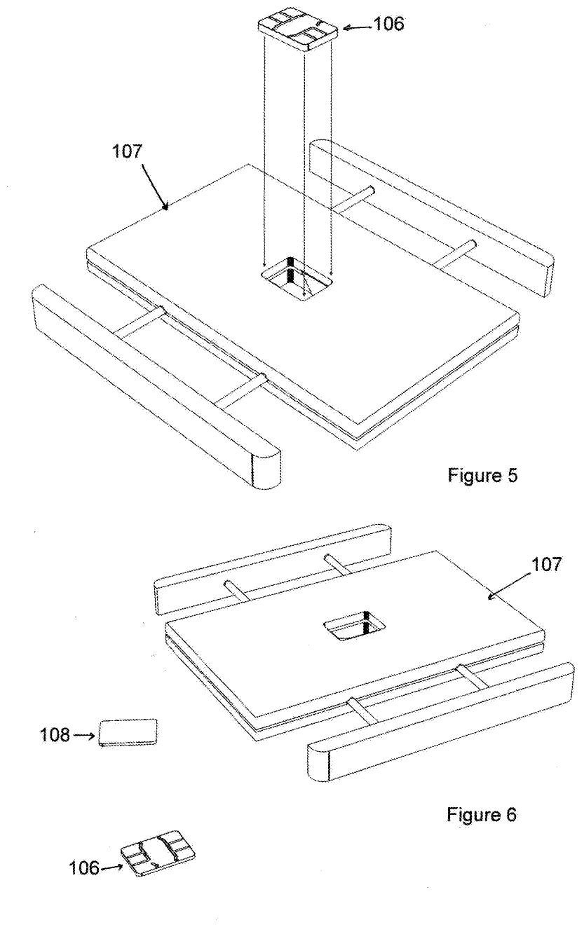

FIG. 5 illustrates an embodiment of an elevated, front, side view of cigar cutter (107) with an EMV chip (106) located overhead of the cutter before insertion.

FIG. 6 illustrates an embodiment of an elevated, front, side view of a cigar cutter (107) with a cut out EMV chip (106) after being inserted into the cutter and the bottom plastic and/or glue removed from the chip (108). Once the EMV chip (106) is placed into the cigar cutter (107), the cutter can be used in a conventional manner to slice off any excess plastic and/or glue (108) attached to the back of the EMV chip (106), and the excess plastic and/or glue (108) can be discarded. The free EMV chip (106) may be further cleaned by hand or with any suitable leaning fluid and used directly.

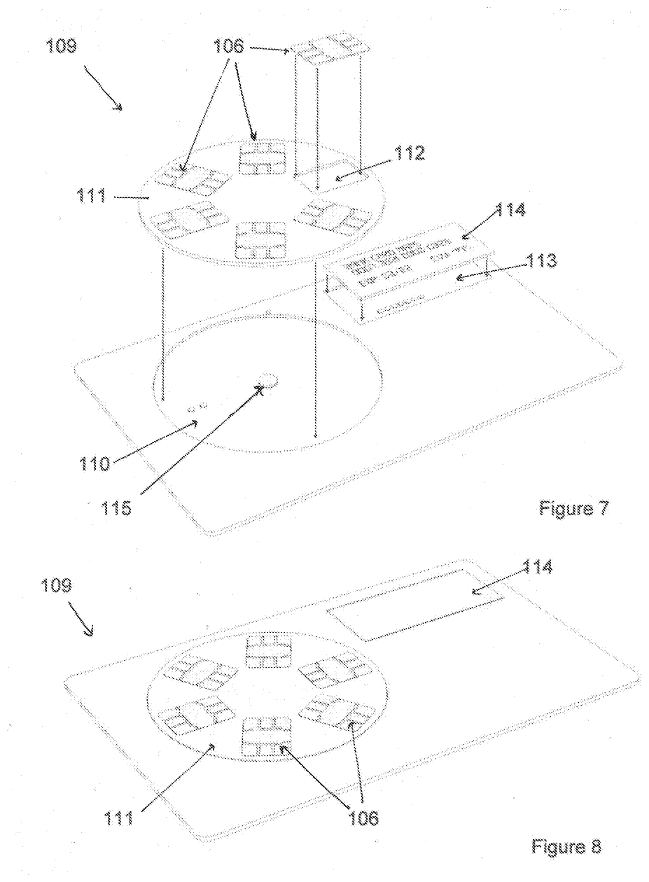

FIG. 7 illustrates an embodiment of an exploded, elevated, front, side view of a credit card or debit card (109) having a disk inlay (110) for connecting with a disk (111). The disk (111) includes one or more EMV chip slots or inlays (112) for connecting with one or more EMV chips (106). In an embodiment, the one or more EMV chips (106) can be secured to the one or more EMP chip slots or inlays (112) by any means, including but not limited to glues, resins, fusion, clips, and the like. Also shown in the credit card or debit card (109) is a display inlay (113) for connecting with an electronic display (114). In an embodiment, the electronic display (114) can be secured to the display inlay (113) by any means, including but not limited to glues, resins, fusion, clips, and the like. The exploded view of this figures illustrates an embodiment of how the disk (111) can connect with the credit card or debit card (109) through a centrally located post (115), on which the disk (11) is secured to and can rotate upon. In addition, the underside of the disk (111) can include a receiving unit (not shown) for receiving the centrally located post (115). Alternatively, a centrally located post can be located on the underside of the disk, and the receiving unit can be located on the disk inlay of the credit card or debit card. The disk (111) can be rotated or spun around to a desired EMV chip (106) and used in various devices as those for traditional card EMV chip cards.

FIG. 8 illustrates an embodiment of an elevated, front, side view of a credit card or debit card (109) with a disk (111), multiple EMV chips (106), and an electronic display screen (114). As shown in this figure, the disk, EMV chips, and electronic display screen can lie substantially flat against the credit card or debit card. Furthermore, a suitable protective covering, such as a plastic sheet and the like, can be used to cover the surface of the credit card or debit card.

In embodiments, the credit card or debit card can be made of stainless steel or any other suitable metal or alloy. In addition, the credit card or debit card can be made of suitable plastic, polymeric or reinforced fiber material. Further, the card can be of any desired colored including but not limited to black, gold (rose, white or yellow gold), titanium, and the like or any combinations thereof. In addition, the card can include imprinted information including but not limited to the user's name, account information, and any desired ornamental design.

The various embodiments described herein for removing an EMV chip from a plastic credit card or debit card and placing the removed EMV chip onto a blank credit card or debit card, can be extended to providing a card with more than one EMV chip. For example, the technology allows for the production of a card having from one to six EMV chips. In other embodiments, the card having from one to six EMV chips further includes one or more magnetic strips as used in the credit card and debit card field of art. In addition, these cards can be physically inserted into a card reader or can be read over short distances using radio-frequency identification (RFID), near field communication, Bluetooth and/or Tap-to-Pay technologies.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A credit card or debit card, comprising:
at least one rotatable disk arranged onto a top face or a bottom face of the credit card or debit card; and
one or more EMV chips arranged onto the at least one rotatable disk.

2. The credit card or debit card of claim 1, wherein the at least one rotatable disk is reversibly attached to the credit card or debit card.

3. The credit card or debit card of claim 1, wherein the at least one rotatable disk is level with the top face or the bottom face of the credit card or debit card.

4. The credit card or debit card of claim 1, further comprising at least one slot for securing an EMV chip in the at least one rotatable disk.

5. The credit card or debit card of claim 4, wherein the at least one rotatable disk includes 1 to 6 slots for holding 1 to 6 EMV chips, respectively.

6. The credit card or debit card of claim 1, wherein the one or more EMV chips are located on a periphery of the at least one rotatable disk.

7. The credit card or debit card of claim 6, wherein 1 to 6 EMV chips are located on the periphery of the at least one rotatable disk.

8. The credit card or debit card of claim 1, further comprising at least one mark in the at least one rotatable disk identifying each of the one or more EMV chips, respectively.

9. The credit card or debit card of claim 1, further comprising at least one display screen, wherein a chosen EMV chip triggers card information onto the display screen.

10. The credit card or debit card of claim 1, wherein the credit card or debit card is a stainless-steel metal credit card or stainless-steel metal debit card.

11. A method of preparing a credit card or debit card, comprising:
removing one or more EMV chips from one or more credit cards or debit cards;
trimming off any excess glue or plastic from the removed one or more EMV chips; and
inserting the trimmed one or more EMV chips onto a rotatable disk arranged onto a top face or a bottom face of a blank credit card or debit card.

12. The method of claim 11, wherein the at least one rotatable disk is reversibly attached to the blank credit card or debit card.

13. The method of claim 11, wherein the at least one rotatable disk is level with the top face or the bottom face of the blank credit card or debit card.

14. The method of claim 11, further comprising at least one slot for securing an EMV chip in the at least one rotatable disk.

15. The method of claim 14, wherein the at least one rotatable disk includes 1 to 6 slots for holding 1 to 6 EMV chips, respectively.

16. The method of claim 1, wherein the one or more EMV chips are located on a periphery of the at least one rotatable disk.

17. The method of claim 16, wherein 1 to 6 EMV chips are located on the periphery of the at least one rotatable disk.

18. The method of claim 11, further comprising at least one mark in the at least one rotatable disk identifying each of the one or more EMV chips, respectively.

19. The method of claim 11, further comprising at least one display screen, wherein a chosen EMV chip triggers card information onto the display screen.

20. The method of claim 11, wherein the blank credit card or debit card is a blank stainless-steel metal credit card or stainless-steel metal debit card.
